(19) United States
(12) Patent Application Publication
(10) Pub. No.: US 2024/0326811 A1
(43) Pub. Date: Oct. 3, 2024

(54) VEHICLE CONTROL DEVICE, VEHICLE CONTROL METHOD, AND NON-TRANSITORY RECORDING MEDIUM

(71) Applicant: TOYOTA JIDOSHA KABUSHIKI KAISHA, Aichi-ken (JP)

(72) Inventors: Terumoto KOMORI, Shizuoka-ken (JP); Satoru AKAHANE, Tokyo-to (JP); Shimpei KOKUBO, Tokyo-to (JP)

(21) Appl. No.: 18/604,497

(22) Filed: Mar. 14, 2024

(30) Foreign Application Priority Data
Mar. 29, 2023 (JP) 2023-053570

(51) Int. Cl. B60W 30/18; B60W 30/16

(52) U.S. Cl. CPC B60W 30/18009; B60W 30/16; B60W 2420/403; B60W 2552/10; B60W 2556/40; B60W 2556/50; B60W 2720/106

(57) ABSTRACT

A vehicle control device includes a processor which acquires nearby vehicle information and surrounding road environment information of a host vehicle and performs blind spot avoidance control for making the host vehicle avoid traveling in a blind spot of a nearby vehicle based on the nearby vehicle information. The processor performs at least one of suppression of the blind spot avoidance control while the host vehicle is traveling in passing lane or priority lane based on the surrounding road environment information and suppression of the blind spot avoidance control while the host vehicle is traveling in a merged section based on the surrounding road environment information.

### FIELD

The present disclosure relates to vehicle control device, vehicle control method, and non-transitory recording medium.

### BACKGROUND

PTL 1 (Japanese Patent No. 4045811) describes the art of automatically and proactively decreasing a time period or possibility of a host vehicle being positioned in a blind spot of a driver of another vehicle. In the art described in PTL 1, the target speed of the host vehicle is adjusted so that the time period or probability of the host vehicle being positioned in the blind spot of the driver of another vehicle is reduced based on the traveling state of another vehicle.

For example, if blind spot avoidance control which is control for making the host vehicle avoid traveling in the blind spot of the nearby vehicle (another vehicle) is performed while the host vehicle is traveling in a passing lane etc., the host vehicle is liable to end up being unable to pass the nearby vehicle. Further, for example, if blind spot avoidance control which is control for making the host vehicle avoid traveling in a blind spot of a nearby vehicle traveling in a lane positioned on for example an opposite side of a merging lane across a merged lane adjoining the merging lane (for example, control for making the host vehicle decelerate etc.) is performed while the host vehicle is traveling in the merged lane and a merging vehicle is traveling in the merging lane, the action of the merging vehicle merging from the merging lane to the merged lane is liable to be obstructed by the host vehicle.

### SUMMARY

In consideration of the above-mentioned point, the present disclosure has as its object the provision of vehicle control device, vehicle control method, and non-transitory recording medium enabling blind spot avoidance control for making a host vehicle avoid traveling in a blind spot of a nearby vehicle to be suitably performed.
(1) One aspect of the present disclosure is a vehicle control device including a processor configured to: acquire nearby vehicle information and surrounding road environment information of a host vehicle; and perform blind spot avoidance control for making the host vehicle avoid traveling in a blind spot of a nearby vehicle based on the nearby vehicle information, wherein the processor is configured to perform at least one of suppression of the blind spot avoidance control while the host vehicle is traveling in passing lane or priority lane based on the surrounding road environment information and suppression of the blind spot avoidance control while the host vehicle is traveling in a merged section based on the surrounding road environment information.
(2) In the vehicle control device of the aspect (1), the processor may be configured to determine whether to suppress the blind spot avoidance control and calculate acceleration and deceleration of the host vehicle for suppressing the blind spot avoidance control.
(3) In the vehicle control device of the aspect (1) or (2), the processor may be configured to determine whether the host vehicle is traveling in any of the passing lane, HOV (high occupancy vehicle) lane, and express lane based on at least one of position information and map information of the host vehicle obtained from GPS unit and map information unit provided in the host vehicle and image data of the vicinity of the host vehicle obtained from a camera provided in the host vehicle.
(4) In the vehicle control device of any of the aspects (1) to (3), the processor may be configured to determine whether the host vehicle is traveling in the merged section based on at least one of position information and map information of the host vehicle obtained from GPS unit and map information unit provided in the host vehicle and image data of the vicinity of the host vehicle obtained from a camera provided in the host vehicle.
(5) In the vehicle control device of any of the aspects (1) to (4), a zebra zone may exist between a merged lane which is a lane including the merged section and a merging lane, and the merged section may be comprised of a section between a hard nose and a soft nose in the merged lane and a section between the soft nose and a merging end.
(6) In the vehicle control device of any of the aspects (1) to (5), a zebra zone may not exist between a merged lane which is a lane including a merged section and a merging lane, and the merged section may be comprised of a section between a position at a predetermined distance from a merging end and the merging end in the merged lane.
(7) In the vehicle control device of any of the aspects (1) to (6), when the host vehicle moves from outside the merged section to inside the merged section in a state in which the processor is performing the blind spot avoidance control, the processor may not be configured to perform control for making the host vehicle decelerate for performing the blind spot avoidance control, but may be configured to perform speed increase suppression control of the host vehicle, and when the host vehicle moves from outside the merged section to inside the merged section in a state in which the processor is not performing the blind spot avoidance control, the processor may not be configured to start the blind spot avoidance control.
(8) Another aspect of the present disclosure is a vehicle control method including: acquiring nearby vehicle information and surrounding road environment information of a host vehicle; and performing blind spot avoidance control for making the host vehicle avoid traveling in a blind spot of a nearby vehicle based on the nearby vehicle information, wherein at least one of suppression of the blind spot avoidance control while the host vehicle is traveling in passing lane or priority lane based on the surrounding road environment information and suppression of the blind spot avoidance control while the host vehicle is traveling in a merged section based on the surrounding road environment information, is performed.
(9) Another aspect of the present disclosure is a non-transitory recording medium having recorded thereon a computer program for causing a processor to execute a process including: acquiring nearby vehicle information and surrounding road environment information of a host vehicle; and performing blind spot avoidance control for making the host vehicle avoid traveling in a blind spot of a nearby vehicle based on the nearby vehicle information, wherein at least one of suppression of the blind spot avoidance control while the host vehicle is traveling in passing lane or priority lane based on the surrounding road environment information and suppression of the blind spot avoidance control while the host vehicle is traveling in a merged section based on the surrounding road environment information, is performed.

According to the present disclosure, it is possible to suitably perform blind spot avoidance control for making a host vehicle avoid traveling in a blind spot of a nearby vehicle.

### BRIEF DESCRIPTION OF DRAWINGS

FIG. 1 is a view showing one example of the schematic configuration of a host vehicle 10 to which a vehicle control device 12 of a first embodiment is applied.

FIG. 2 is a view for explaining the reason why an operation determination part 232A determines to suppress blind spot avoidance control while the host vehicle 10 is traveling in a passing lane LN1.

FIG. 3 is a view for explaining the reason why the operation determination part 232A determines to suppress the blind spot avoidance control while the host vehicle 10 is traveling in a merged lane LN2.

FIG. 4A shows an example where it is determined that the host vehicle 10 is not traveling in the passing lane LN1.

FIG. 4B shows an example where it is determined that the host vehicle 10 is traveling in the passing lane LN1.

FIG. 5 is a view for explaining a first example of a technique for determining whether the host vehicle 10 is traveling in a merged section (suppression area) SA2.

FIG. 6 is a view for explaining a modification of the first example of the technique for determining whether the host vehicle 10 is traveling in the merged section (suppression area) SA2.

FIG. 7 is a view for explaining a third example of the technique for determining whether the host vehicle 10 is traveling in the merged section (suppression area) SA2.

FIG. 8 is a flow chart for explaining one example of the blind spot avoidance control performed by a processor 23.

### DESCRIPTION OF EMBODIMENTS

Below, referring to the drawings, embodiments of vehicle control device, vehicle control method, and non-transitory recording medium of the present disclosure will be explained.

### First Embodiment

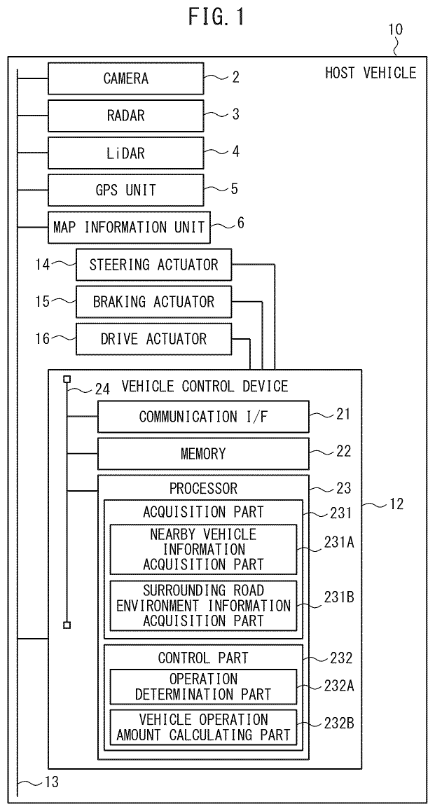

FIG. 1 is a view showing one example of the schematic configuration of a host vehicle 10 to which a vehicle control device 12 of a first embodiment is applied.

In the example shown in FIG. 1, the host vehicle 10 is provided with camera 2, radar 3, LiDAR (Light Detection And Ranging) 4, and vehicle control device 12. The camera 2 captures images of nearby vehicle of the host vehicle 10 and road environment in the vicinity of the host vehicle 10 (for example, the road structure, rules, etc.) and generates image data showing the nearby vehicle and the road environment of the vicinity and sends it to the vehicle control device 12. The radar 3 is, for example, millimeter wave radar, 24 GHz band narrow band region radar, etc., detects relative position and relative speed of the nearby vehicle and the road structure in the vicinity with respect to the host vehicle 10, and sends the result of detection to the vehicle control device 12. The LiDAR 4 detects the relative position and the relative speed of the nearby vehicle and the road structure in the vicinity with respect to the host vehicle 10 and sends the result of detection to the vehicle control device 12.

In another example, the host vehicle 10 may also be provided with a sonar (not shown). In this example, the sonar detects the distance between the host vehicle 10 and the nearby vehicle and the road structure in the vicinity and sends the result of detection to the vehicle control device 12.

In the example shown in FIG. 1, the host vehicle 10 is provided with GPS (global positioning system) unit 5 and map information unit 6. The GPS unit 5 acquires positional information showing the current position of the host vehicle 10 based on the GPS signal and sends the positional information of the host vehicle 10 to the vehicle control device 12. The map information unit 6 is, for example, formed inside HDD (hard disk drive), SSD (solid state drive), or other storage mounted in the host vehicle 10. The map information held by the map information unit 6 includes the road structure (position of the road, shape of the road, lane structure, etc.), rules, and various other types of information. The camera 2, the radar 3, the LiDAR 4, the GPS unit 5, the map information unit 6, and the vehicle control device 12 are connected via an internal vehicle network 13.

Further, the host vehicle 10 is provided with steering actuator 14, braking actuator 15, and drive actuator 16. The steering actuator 14 has the function of steering the host vehicle 10. The steering actuator 14 includes, for example, power steering system, steer-by-wire steering system, rear wheel steering system, or the like. The braking actuator 15 has the function of making the host vehicle 10 decelerate. The braking actuator 15 includes, for example, hydraulic brake, electric power regeneration brake, or the like. The drive actuator 16 has the function of making the host vehicle 10 accelerate. The drive actuator 16, for example, includes engine, EV (electric vehicle) system, hybrid system, fuel cell system, or the like.

In the example shown in FIG. 1, the vehicle control device 12 is configured by an autonomous driving control ECU (electronic control unit). The vehicle control device 12 (autonomous driving control ECU) can control the host vehicle 10 by a driving control level of level 3 according to the definition of the SAE (Society of Automotive Engineers), that is, a driving control level where the driver does not have to operate the steering actuator 14, the braking actuator 15, and the drive actuator 16 and the driver does not have to monitor the vicinity of the host vehicle 10. Furthermore, the vehicle control device 12 can control the host vehicle 10 by a driving control level at which the driver is involved in the driving of the host vehicle 10, for example, a driving control level of levels 0 to 2 according to the definition of the SAE.

The vehicle control device 12 is comprised of a microcomputer having communication interface (I/F) 21, memory 22, and processor 23. The communication interface 21, the memory 22, and the processor 23 are connected via signal lines 24. The communication interface 21 has an interface circuit for connecting the vehicle control device 12 to the internal vehicle network 13. The memory 22 is one example of the storage part and, for example, has volatile semiconductor memory and nonvolatile semiconductor memory. The memory 22 stores a program used in the processing performed by the processor 23 and various types of data. The processor 23 has the function of performing blind spot avoidance control for making the host vehicle 10 avoid traveling in a blind spot of the nearby vehicle (in more detail, the blind spot of the driver of the nearby vehicle).

In the example shown in FIG. 1, the vehicle control device 12 is provided with a single processor 23, but in another example, the vehicle control device 12 may also be provided with a plurality of processors. Further, in the example shown in FIG. 1, the vehicle control device 12 (autonomous driving control ECU) is comprised of a single ECU, but in another example, the vehicle control device 12 may be comprised of a plurality of ECUs.

In the example shown in FIG. 1, the processor 23 is provided with acquisition part 231 and control part 232. The acquisition part 231 is provided with nearby vehicle information acquisition part 231A and surrounding road environment information acquisition part 231B.

The nearby vehicle information acquisition part 231A acquires nearby vehicle information which is information showing the position, the speed, etc. of the nearby vehicle of the host vehicle 10 (other vehicle existing in vicinity of host vehicle 10). Specifically, the nearby vehicle information acquisition part 231A has the function of recognizing the position, the speed, etc. of the nearby vehicle based on the image data showing the nearby vehicle sent from the camera 2. Further, the nearby vehicle information acquisition part 231A has the function of recognizing the position, the speed, etc. of the nearby vehicle based on the results of detection of the relative position and the relative speed of the nearby vehicle with respect to the host vehicle 10 sent from the radar 3. Furthermore, the nearby vehicle information acquisition part 231A has the function of recognizing the position, the speed, etc. of the nearby vehicle based on the results of detection of the relative position and the relative speed of the nearby vehicle with respect to the host vehicle 10 sent from the LiDAR 4.

In another example, the nearby vehicle information acquisition part 231A may have the function of recognizing the position, the speed, etc. of the nearby vehicle based on the result of detection of the distance between the host vehicle 10 and the nearby vehicle sent from the sonar.

In the example shown in FIG. 1, the surrounding road environment information acquisition part 231B acquires surrounding road environment information which is information showing road structure, rules, etc. of the vicinity of the host vehicle 10. Specifically, the surrounding road environment information acquisition part 231B has the function of recognizing the road structure, the rules, etc. of the vicinity of the host vehicle 10 based on the image data showing the road environment (road structure, rules, etc.) of the vicinity of the host vehicle 10 sent from the camera 2. Further, the surrounding road environment information acquisition part 231B has the function of recognizing the road structure, the rules, etc. of the vicinity of the host vehicle 10 based on the map information sent from the map information unit 6.

That is, the acquisition part 231 has the function of recognizing objects (nearby vehicles and surrounding road environment) existing in the vicinity of the host vehicle 10. The object recognition may be performed based on information of any of the camera 2, the radar, the LiDAR 4, the GPS unit 5, and the map information unit 6. The object recognition may also be performed by sensor fusion combining several among these. In object recognition, the type of the object, for example, whether the object is a moving object or a stationary object, is determined. When the object is a moving body, its position and speed are calculated. The position and speed of the moving body is, for example, calculated in a reference coordinate system centered about the host vehicle 10, having the width direction of the host vehicle 10 as the abscissa, and having the direction of travel as the ordinate.

In the example shown in FIG. 1, the acquisition part 231 has a nearby vehicle detection function of detecting the nearby vehicle to be monitored among objects recognized by the object recognition function. When the nearby vehicle is traveling in a lane adjoining the lane in which the host vehicle 10 is traveling and the host vehicle 10 is traveling in the blind spot of the nearby vehicle, the nearby vehicle is detected as the nearby vehicle to be monitored by the nearby vehicle detection function. Specifically, when the host vehicle 10 is for example continuing to travel for greater than or equal to a predetermined time period in the blind spot of the nearby vehicle traveling in the adjoining lane, the nearby vehicle is detected as the nearby vehicle to be monitored by the nearby vehicle detection function.

The control part 232 performs control of the steering actuator 14, the braking actuator 15, the drive actuator 16, etc. based on the information acquired by the acquisition part 231.

The control part 232 has a first function of performing blind spot avoidance control for making the host vehicle 10 avoid traveling in the blind spot of the nearby vehicle based on the nearby vehicle information acquired by the nearby vehicle information acquisition part 231A. The control part 232 can perform the blind spot avoidance control for making the host vehicle 10 avoid traveling in the blind spot of the nearby vehicle as the nearby vehicle to be monitored when the nearby vehicle to be monitored is detected by the nearby vehicle detection function.

The control part 232 can perform control, for example, for making the braking actuator 15 operate for making the host vehicle 10 decelerate, control for making the drive actuator 16 operate for making the host vehicle 10 accelerate, etc. as the blind spot avoidance control for making the host vehicle 10 avoid traveling in the blind spot of the nearby vehicle as the nearby vehicle to be monitored.

Further, the control part 232 has a second function of suppressing the blind spot avoidance control based on the surrounding road environment information acquired by the surrounding road environment information acquisition part 231B while the host vehicle 10 is traveling in any of passing lane, HOV (high occupancy vehicle) lane as a priority lane, and express lane as the priority lane.

Further, the control part 232 has a third function of suppressing the blind spot avoidance control based on the surrounding road environment information acquired by the surrounding road environment information acquisition part 231B while the host vehicle 10 is traveling in a merged section SA2 (see FIG. 5 etc.).

Specifically, the control part 232 can, for example, suspend performance of the blind spot avoidance control for suppressing the blind spot avoidance control. When the blind spot avoidance control for making the host vehicle 10 decelerate is performed, the control part 232 can make the operation amount of the braking actuator 15 which makes the host vehicle 10 decelerate decrease so as to suppress the blind spot avoidance control. When the blind spot avoidance control for making the host vehicle 10 accelerate is performed, the control part 232 can make the operation amount of the drive actuator 16 which makes the host vehicle 10 accelerate decrease so as to suppress the blind spot avoidance control.

In the example shown in FIG. 1 (first example of the host vehicle 10 to which the vehicle control device 12 of the first embodiment is applied), the control part 232 has the first function, the second function, and the third function, but in a second example of the host vehicle 10 to which the vehicle control device 12 of the first embodiment is applied, the control part 232 may have the first function and the second function, but not have the third function. In a third example of the host vehicle 10 to which the vehicle control device 12 of the first embodiment is applied, the control part 232 may have the first function and the third function, but not have the second function.

In the example shown in FIG. 1, the control part 232 is provided with an operation determination part 232A and a vehicle operation amount calculating part 232B. The operation determination part 232A determines whether to suppress the blind spot avoidance control for making the host vehicle 10 avoid traveling in the blind spot of the nearby vehicle.

Specifically, in the example shown in FIG. 1 (first example of the host vehicle 10 to which the vehicle control device 12 of the first embodiment is applied), the operation determination part 232A determines to suppress the blind spot avoidance control while the host vehicle 10 is traveling in any of the passing lane in road management, the HOV lane as the priority lane, and the express lane as the priority lane. Furthermore, the operation determination part 232A determines to suppress the blind spot avoidance control while the host vehicle 10 is traveling in the merged section.

In a second example of the host vehicle 10 to which the vehicle control device 12 of the first embodiment is applied, the operation determination part 232A determines to suppress the blind spot avoidance control while the host vehicle 10 is traveling in any of the passing lane in road management, the HOV lane as the priority lane, and the express lane as the priority lane. On the other hand, the operation determination part 232A does not determine whether to suppress the blind spot avoidance control while the host vehicle 10 is traveling in the merged section.

In a third example of the host vehicle 10 to which the vehicle control device 12 of the first embodiment is applied, the operation determination part 232A determines to suppress the blind spot avoidance control while the host vehicle 10 is traveling in the merged section. On the other hand, the operation determination part 232A does not determine whether to suppress the blind spot avoidance control while the host vehicle 10 is traveling in any of the passing lane in road management, the HOV lane as the priority lane, and the express lane as the priority lane.

In the example shown in FIG. 1, the vehicle operation amount calculating part 232B has a function of calculating operation amount of the steering actuator 14, the braking actuator 15, the drive actuator 16, etc. of the host vehicle 10. Specifically, the vehicle operation amount calculating part 232B has at least the function of calculating acceleration and deceleration of the host vehicle 10 for suppressing the blind spot avoidance control. That is, when the operation determination part 232A determines to suppress the blind spot avoidance control, the vehicle operation amount calculating part 232B calculates the acceleration and the deceleration of the host vehicle 10 for suppressing the blind spot avoidance control.

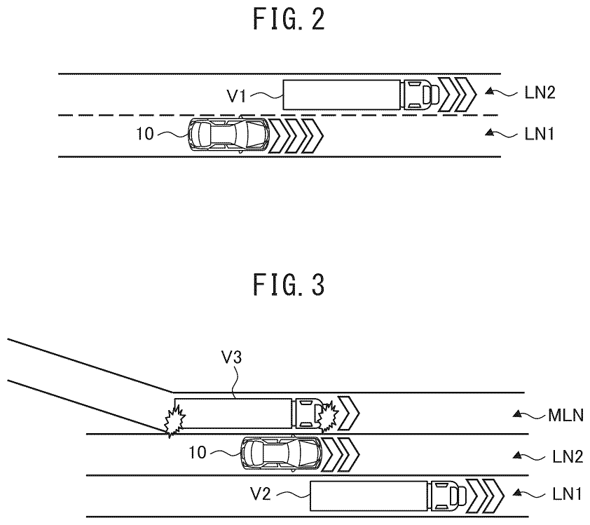

FIG. 2 is a view for explaining the reason why the operation determination part 232A determines to suppress the blind spot avoidance control while the host vehicle 10 is traveling in the passing lane LN1. In more detail, FIG. 2 shows an example of a state where the host vehicle 10 is traveling in the passing lane LN1 and the host vehicle 10 is traveling in the blind spot of the nearby vehicle V1 traveling in a lane LN2 adjacent to the passing lane LN1.

In the example shown in FIG. 2, the nearby vehicle V1 is, for example, traveling at a speed of 80 km per hour, and the host vehicle 10 is, for example, traveling at the speed of 100 km per hour in the blind spot of the nearby vehicle V1 and passing the nearby vehicle V1. In the state shown in FIG. 2, if blind spot avoidance control of the host vehicle 10 is performed and the host vehicle 10 is made to decelerate, the host vehicle 10 ends up becoming unable to pass the nearby vehicle V1. That is, if the blind spot avoidance control of the host vehicle 10 is performed, there is the possibility that smooth traffic of the host vehicle 10 will be obstructed.

Therefore, in the example shown in FIG. 1 (first example of the host vehicle 10 to which the vehicle control device 12 of the first embodiment is applied), while the host vehicle 10 is traveling in the passing lane, the operation determination part 232A determines to suppress the blind spot avoidance control performed along with the host vehicle 10 traveling in the blind spot of the nearby vehicle V1. Furthermore, the vehicle operation amount calculating part 232B calculates the acceleration and the deceleration of the host vehicle 10 for suppressing the blind spot avoidance control.

In the example where for example control is performed for making the host vehicle 10 decelerate as the blind spot avoidance control for making the host vehicle 10 avoid traveling in the blind spot of the nearby vehicle V1, the control part 232 suppresses the blind spot avoidance control by, for example, performing control for suspending performance of the blind spot avoidance control, control for making the operation amount of the braking actuator 15 for making the host vehicle 10 decelerate decrease (for example, control for not allowing the speed of the host vehicle 10 to decrease down to the speed of the nearby vehicle V1), etc. As a result, the host vehicle 10 can pass the nearby vehicle V1.

Similarly, in the example shown in FIG. 1 (the first example of the host vehicle 10 to which the vehicle control device 12 of the first embodiment is applied), while the host vehicle 10 is traveling in the HOV lane (not shown) as the priority lane, the operation determination part 232A determines to suppress the blind spot avoidance control performed along with the host vehicle 10 traveling in the blind spot of the nearby vehicle (not shown) traveling in the lane adjacent to the HOV lane (not shown). Furthermore, the vehicle operation amount calculating part 232B calculates the acceleration and the deceleration of the host vehicle 10 for suppressing the blind spot avoidance control.

When control for making the host vehicle 10 decelerate is performed for making the host vehicle 10 avoid traveling in the blind spot of the nearby vehicle traveling in the lane adjacent to the HOV lane as the blind spot avoidance control, the control part 232 suppresses the blind spot avoidance control by, for example, performing control for suspending performance of the blind spot avoidance control, control for making the operation amount of the braking actuator 15 for making the host vehicle 10 decelerate decrease, etc. As a result, the host vehicle 10 can realize traveling according to the purpose of the HOV lane.

Further, in the example shown in FIG. 1 (the first example of the host vehicle 10 to which the vehicle control device 12 of the first embodiment is applied), while the host vehicle 10 is traveling in the express lane as the priority lane (not shown), the operation determination part 232A determines to suppress the blind spot avoidance control performed along with the host vehicle 10 traveling in the blind spot of the nearby vehicle (not shown) traveling in the lane adjacent to the express lane (not shown). Furthermore, the vehicle operation amount calculating part 232B calculates the acceleration and the deceleration of the host vehicle 10 for suppressing the blind spot avoidance control.

When control for making the host vehicle 10 decelerate is performed for making the host vehicle 10 avoid traveling in the blind spot of the nearby vehicle traveling in the lane adjacent to the express lane as the blind spot avoidance control, the control part 232 suppresses the blind spot avoidance control by, for example, performing the control for suspending performance of the blind spot avoidance control, the control for making the operation amount of the braking actuator 15 for making the host vehicle 10 decelerate decrease, etc. As a result, the host vehicle can realize traveling according to the purpose of the express lane.

In a fourth example of the host vehicle 10 to which the vehicle control device 12 of the first embodiment is applied, while the host vehicle 10 is traveling in the passing lane, the operation determination part 232A determines whether to suppress the blind spot avoidance control for making the host vehicle 10 avoid traveling in the blind spot of the nearby vehicle, but while the host vehicle 10 is traveling in the HOV lane, the operation determination part 232A may not determine whether to suppress the blind spot avoidance control and, while the host vehicle 10 is traveling in the express lane, the operation determination part 232A may not determine whether to suppress the blind spot avoidance control either.

In a fifth example of the host vehicle 10 to which the vehicle control device 12 of the first embodiment is applied, while the host vehicle 10 is traveling in the HOV lane as the priority lane, the operation determination part 232A determines whether to suppress the blind spot avoidance control, but while the host vehicle 10 is traveling in the passing lane, the operation determination part 232A may not determine whether to suppress the blind spot avoidance control and, while the host vehicle 10 is traveling in the express lane, the operation determination part 232A may not determine whether to suppress the blind spot avoidance control either.

In a sixth example of the host vehicle 10 to which the vehicle control device 12 of the first embodiment is applied, while the host vehicle 10 is traveling in the express lane as the priority lane, the operation determination part 232A determines whether to suppress the blind spot avoidance control, but while the host vehicle 10 is traveling in the passing lane, the operation determination part 232A may not determine whether to suppress the blind spot avoidance control and, while the host vehicle 10 is traveling in the HOV lane, the operation determination part 232A may not determine whether to suppress the blind spot avoidance control either.

In a seventh example of the host vehicle 10 to which the vehicle control device 12 of the first embodiment is applied, while the host vehicle 10 is traveling in the passing lane, the operation determination part 232A determines whether to suppress the blind spot avoidance control, while the host vehicle 10 is traveling in the HOV lane as the priority lane, the operation determination part 232A determines whether to suppress the blind spot avoidance control, but while the host vehicle 10 is traveling in the express lane, the operation determination part 232A may not determine whether to suppress the blind spot avoidance control.

In an eighth example of the host vehicle 10 to which the vehicle control device 12 of the first embodiment is applied, while the host vehicle 10 is traveling in the passing lane, the operation determination part 232A determines whether to suppress the blind spot avoidance control and while the host vehicle 10 is traveling in the express lane as the priority lane, the operation determination part 232A determines whether to suppress the blind spot avoidance control, but while the host vehicle 10 is traveling in the HOV lane, the operation determination part 232A may not determine whether to suppress the blind spot avoidance control.

In a ninth example of the host vehicle 10 to which the vehicle control device 12 of the first embodiment is applied, while the host vehicle 10 is traveling in the HOV lane as the priority lane, the operation determination part 232A determines whether to suppress the blind spot avoidance control and while the host vehicle 10 is traveling in the express lane as the priority lane, the operation determination part 232A determines whether to suppress the blind spot avoidance control, but while the host vehicle 10 is traveling in the passing lane, the operation determination part 232A may not determine whether to suppress the blind spot avoidance control.

FIG. 3 is a view for explaining the reason why the operation determination part 232A determines to suppress the blind spot avoidance control while the host vehicle 10 is traveling in the merged lane LN2 (in more detail, the merged section (suppression area) SA2 (see FIG. 5 etc.)) In more detail, FIG. 3 shows one example of the state where the host vehicle 10 is traveling in the merged lane LN2 and the host vehicle 10 is traveling in the blind spot of the nearby vehicle V2 traveling in the passing lane LN1 adjacent to the merged lane LN2.

In the example shown in FIG. 3, the nearby vehicle V2 is, for example, traveling at the speed of 80 km per hour, the host vehicle 10 is, for example, traveling at the speed of 80 km per hour, and a merging vehicle (nearby vehicle) V3 is traveling in a merging lane MLN adjacent to the merged lane LN2 at, for example, the speed of 40 km per hour and trying to merge from the merging lane MLN to the merged lane LN2. In the state shown in FIG. 3, if the blind spot avoidance control of the host vehicle 10 is performed and the host vehicle 10 is made to decelerate, the host vehicle 10 ends up traveling parallel to the merging vehicle V3 and merging of merging vehicle V3 from the merging lane MLN to the merged lane LN2 is obstructed. That is, if the blind spot avoidance control of the host vehicle 10 is performed, there is the possibility that smooth traffic of the merging vehicle V3 will be obstructed.

Therefore, in the example shown in FIG. 1 (first example of the host vehicle 10 to which the vehicle control device 12 of the first embodiment is applied), while the host vehicle 10 is traveling in the merged lane LN2 (in more detail, the merged section SA2 of the merged lane LN2), the operation determination part 232A determines to suppress the blind spot avoidance control performed along with the host vehicle 10 traveling in the blind spot of the nearby vehicle V2. Furthermore, the vehicle operation amount calculating part 232B calculates the acceleration and the deceleration of the host vehicle 10 for suppressing the blind spot avoidance control.

In the example where for example control is performed for making the host vehicle 10 decelerate as the blind spot avoidance control for making the host vehicle 10 avoid traveling in the blind spot of the nearby vehicle V2, the control part 232 suppresses the blind spot avoidance control by, for example, performing control for suspending performance of the blind spot avoidance control, control for making the operation amount of the braking actuator 15 for making the host vehicle 10 decelerate decrease (for example, control for not allowing the speed of the host vehicle 10 to decrease down to the speed of the merging vehicle V3), etc. As a result, the merging vehicle V3 can smoothly merge from the merging lane MLN to the merged lane LN2 and can become a vehicle following the host vehicle 10.

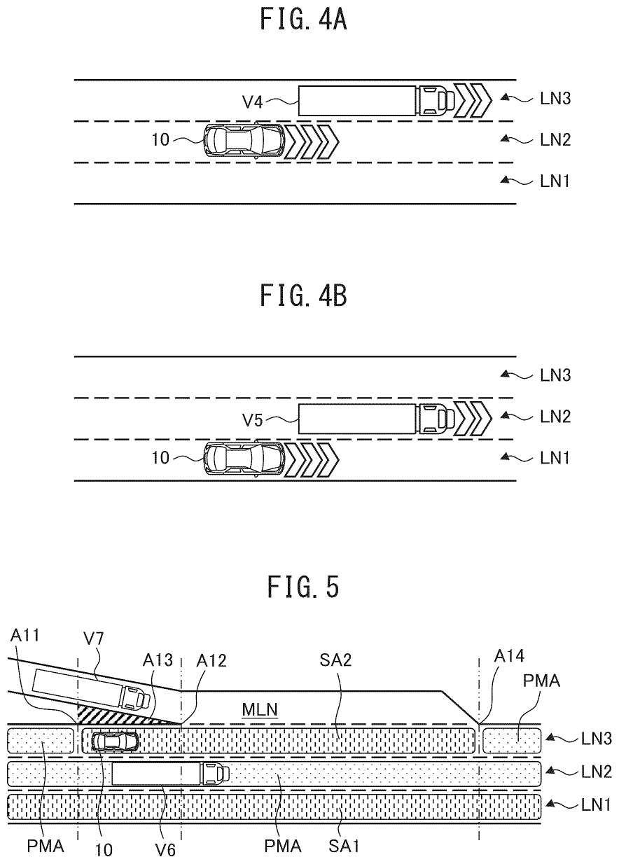

FIG. 4A and FIG. 4B are views for explaining a first example of a technique for determining whether the host vehicle 10 is traveling in the passing lane LN1. In more detail, FIG. 4A shows an example where it is determined that the host vehicle 10 is not traveling in the passing lane LN1, while FIG. 4B shows an example where it is determined that the host vehicle is traveling in the passing lane LN1.

In a first example of the technique for determining whether the host vehicle 10 is traveling in the passing lane LN1, for example, the control part 232 determines whether the host vehicle is traveling in the passing lane LN1 based on the position information of the host vehicle 10 obtained from the GPS unit 5 and the map information obtained from the map information unit 6. In more detail, the control part 232 determines whether the lane in which the host vehicle 10 is traveling is the passing lane LN1 in accordance with whether a lane exists at the higher speed side (lower side in FIG. 4A) from the lane in which the host vehicle 10 is traveling.

Specifically, in the example shown in FIG. 4A, the nearby vehicle V4 is, for example, traveling in the lane LN3 at the speed of 80 km per hour, and the host vehicle 10 is, for example, traveling at the speed of 100 km per hour in the lane LN2. The control part 232 determines whether the host vehicle 10 is traveling in the blind spot of the nearby vehicle V4 based on the nearby vehicle information (the information of the nearby vehicle V4 traveling in the lane LN3) acquired by the nearby vehicle information acquisition part 231A. Further, the control part 232 determines whether the host vehicle 10 is traveling in the lane LN2 based on the position information of the host vehicle 10 obtained from the GPS unit 5 and the map information obtained from the map information unit 6. Furthermore, the control part 232 determines that the lane exists at the higher speed side (lower side in FIG. 4A) from the lane LN2 in which the host vehicle 10 is traveling based on the map information and determines that the lane LN2 in which the host vehicle 10 is traveling is not the passing lane LN1.

Further, the control part 232 determines that the lane LN2 in which the host vehicle 10 is traveling is not either of the HOV lane and the express lane based on the position information of the host vehicle 10 obtained from the GPS unit 5 and the map information obtained from the map information unit 6, determines that the host vehicle 10 is not traveling in the merged section SA2 (see FIG. 5), and performs the blind spot avoidance control for making the host vehicle 10 avoid traveling in the blind spot of the nearby vehicle V4. Specifically, the control part 232 performs the control for making the host vehicle 10 decelerate or the control for making the host vehicle accelerate as the blind spot avoidance control.

That is, in the example shown in FIG. 4A, the control part 232 does not suppress the blind spot avoidance control since the lane LN2 in which the host vehicle 10 is traveling is not any of the passing lane LN1, the HOV lane, and the express lane and the host vehicle 10 is not traveling in the merged section SA2 either.

In the example shown in FIG. 4B, the nearby vehicle V5 is, for example, traveling at the speed of 80 km per hour in the lane LN2, and the host vehicle 10 is, for example, traveling at the speed of 100 km per hour in the lane LN1. The control part 232 determines that the host vehicle is traveling in the blind spot of the nearby vehicle V5 based on the nearby vehicle information (the information of the nearby vehicle V5 traveling in the lane LN2) acquired by the nearby vehicle information acquisition part 231A. Further, the control part 232 determines that the host vehicle 10 is traveling in the lane LN1 based on the position information of the host vehicle 10 obtained from the GPS unit 5 and the map information obtained from the map information unit 6. Furthermore, the control part 232 determines that no lane exists at the higher speed side (lower side in FIG. 4B) from the lane LN1 in which the host vehicle 10 is traveling based on the map information and determines that the lane LN1 in which the host vehicle 10 is traveling is the passing lane.

For this reason, the control part 232 suppresses the blind spot avoidance control performed along with the host vehicle 10 traveling in the blind spot of the nearby vehicle V5.

In an example where the control is performed for making the host vehicle 10 decelerate as the blind spot avoidance control performed along with the host vehicle 10 traveling in the blind spot of the nearby vehicle V5, the control part 232 suppresses the blind spot avoidance control by, for example, performing the control for suspending performance of the blind spot avoidance control, the control for making the operation amount of the braking actuator 15 for making the host vehicle 10 decelerate decrease (for example, the control for not allowing the speed of the host vehicle 10 to decrease down to the speed of the nearby vehicle V5), etc. As a result, the host vehicle 10 can pass the nearby vehicle V5.

In a second example of the technique for determining whether the host vehicle 10 is traveling in the passing lane LN1, the control part 232 determines whether a lane exists at the higher speed side (lower side in FIG. 4A and FIG. 4B) from the lane in which the host vehicle 10 is traveling based on the image data showing the road environment of the vicinity of the host vehicle 10 obtained from the camera 2. When the lane exists at the higher speed side from the lane in which the host vehicle 10 is traveling, the control part 232 determines that the lane in which the host vehicle 10 is traveling is not the passing lane LN1 while when no lane exists at the higher speed side from the lane in which the host vehicle 10 is traveling, the control part 232 determines that the lane in which the host vehicle 10 is traveling is the passing lane LN1.

That is, in the second example of the technique for determining whether the host vehicle 10 is traveling in the passing lane LN1, the control part 232 determines whether the host vehicle 10 is traveling in the passing lane LN1 based on the image data of the vicinity of the host vehicle 10 obtained from the camera 2.

In a third example of the technique for determining whether the host vehicle 10 is traveling in the passing lane LN1, the control part 232 determines whether a zone line at the higher speed side (lower side in FIG. 4A and FIG. 4B) of the lane in which the host vehicle 10 is traveling is a solid line based on the image data showing the road environment of the vicinity of the host vehicle 10 obtained from the camera 2. When the zone line at the higher speed side of the lane in which the host vehicle 10 is traveling is not a solid line (when it is a broken line), the control part 232 determines that the lane in which the host vehicle 10 is traveling is not the passing lane LN1 while when the zone line at the higher speed side of the lane in which the host vehicle 10 is traveling is the solid line, the control part 232 determines that the lane in which the host vehicle is traveling is the passing lane LN1.

That is, in the third example of the technique for determining whether the host vehicle 10 is traveling in the passing lane LN1, the control part 232 determines whether the host vehicle 1 is traveling in the passing lane LN1 based on the image data of the vicinity of the host vehicle 10 obtained from the camera 2.

In the first example of the technique for determining whether the host vehicle 10 is traveling in the passing lane LN1, the control part 232 has the function of determining whether the host vehicle 10 is traveling in the HOV lane as the priority lane based on the position information of the host vehicle 10 obtained from the GPS unit 5 and the map information obtained from the map information unit 6. When the host vehicle 10 is traveling in the HOV lane, the control part 232 suppresses the blind spot avoidance control performed along with the host vehicle 10 traveling in the blind spot of the nearby vehicle (in more detail, the vehicle traveling in the lane adjacent to the HOV lane).

Further, the control part 232 has the function of determining whether the host vehicle 10 is traveling in the express lane as the priority lane based on the position information of the host vehicle 10 obtained from the GPS unit 5 and the map information obtained from the map information unit 6. When the host vehicle 10 is traveling in the express lane, the control part 232 suppresses the blind spot avoidance control performed along with the host vehicle 10 traveling in the blind spot of the nearby vehicle (in more detail, the vehicle traveling in the lane adjacent to the express lane).

That is, the control part 232 has the function of determining whether the host vehicle 10 is traveling in a lane with an attribute given a priority (the passing lane, the HOV lane, or the express lane) over other lanes based on the position information of the host vehicle 10 obtained from the GPS unit 5 and the map information obtained from the map information unit 6.

FIG. 5 is a view for explaining a first example of a technique for determining whether the host vehicle 10 is traveling in the merged section (suppression area) SA2. In more detail, FIG. 5 is a view for explaining one example of a relationship between a merged lane LN3 including the merged section SA2 and a merging lane MLN.

In the first example of the technique for determining whether the host vehicle 10 is traveling in the merged section SA2, the control part 232 determines whether the host vehicle 10 is traveling in the merged section SA2 based on the position information of the host vehicle 10 obtained from the GPS unit 5 and the map information obtained from the map information unit 6.

In the example shown in FIG. 5, the nearby vehicle V6 is traveling in the lane LN2 adjacent to the merged lane LN3, the host vehicle 10 is traveling in the merged lane LN3, and the merging vehicle (nearby vehicle) V7 is traveling in the merging lane MLN adjacent to the merged lane LN3 (in more detail, the merging lane MLN positioned on an opposite side of the lane LN2 across the merged lane LN3) and trying to merge from the merging lane MLN to the merged lane LN3.

The control part 232 determines that the host vehicle 10 is traveling in the blind spot of the nearby vehicle V6 based on the nearby vehicle information (the information of the nearby vehicle V6 traveling in the lane LN2) acquired by the nearby vehicle information acquisition part 231A. Further, the control part 232 determines that the host vehicle 10 is traveling in the merged section (suppression area) SA2 based on the position information of the host vehicle 10 obtained from the GPS unit 5 and the map information obtained from the map information unit 6.

For this reason, the control part 232 suppresses the blind spot avoidance control performed along with the host vehicle 10 traveling in the blind spot of the nearby vehicle V6.

In the example where for example control is performed for making the host vehicle 10 decelerate as the blind spot avoidance control for making the host vehicle 10 avoid traveling in the blind spot of the nearby vehicle V6, the control part 232 suppresses the blind spot avoidance control by, for example, performing the control for suspending performance of the blind spot avoidance control, the control for making the operation amount of the braking actuator 15 for making the host vehicle 10 decelerate decrease (for example, the control for not allowing the speed of the host vehicle 10 to decrease down to the speed of the merging vehicle V7), etc. As a result, the merging vehicle V7 can smoothly merge from the merging lane MLN to the merged lane LN3 and can become a vehicle following the host vehicle 10.

In the example shown in FIG. 5, a zebra zone A13 exists between the merged lane LN3 including the merged section SA2 and the merging lane MLN. The merged section SA2 is comprised of a section between hard nose A11 and soft nose A12 in the merged lane LN3 and a section between the soft nose A12 and a merging end A14.

The merged section SA2 is set to the suppression area in which the blind spot avoidance control performed along with the host vehicle 10 traveling in the blind spot of the nearby vehicle (for example the nearby vehicle V6 etc.) is suppressed. The section other than the merged section SA2 in the merged lane LN3 is set to a permitted area PMA in which the blind spot avoidance control performed along with the host vehicle 10 traveling in the blind spot of the nearby vehicle (not shown) is not suppressed.

The lane LN2 is set to the permitted area PMA in which the blind spot avoidance control performed along with the host vehicle 10 traveling in the blind spot of the nearby vehicle is not suppressed. The passing lane LN1 is set to the suppression area SA1 in which the blind spot avoidance control performed along with the host vehicle 10 traveling in the blind spot of the nearby vehicle is suppressed.

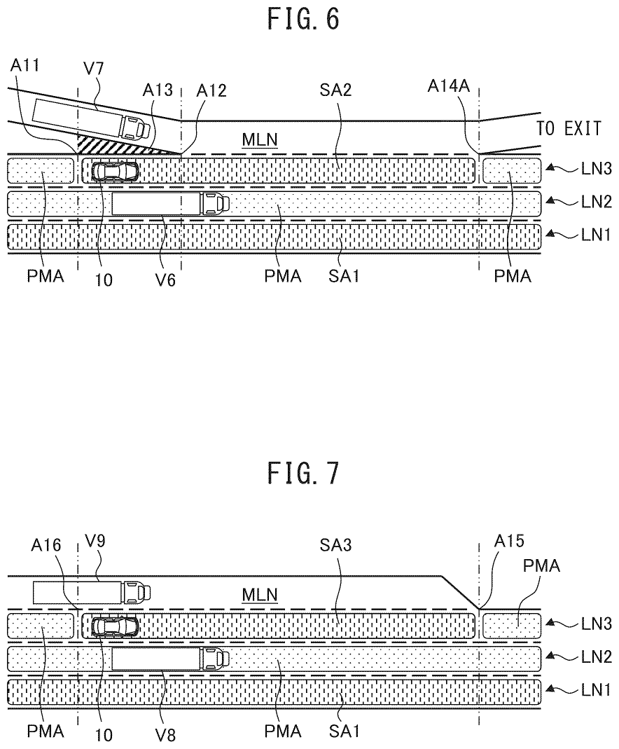

FIG. 6 is a view for explaining a modification of the first example of the technique for determining whether the host vehicle 10 is traveling in the merged section (suppression area) SA2. In more detail, FIG. 6 is the view for explaining the modification of the first example of the relationship between the merged lane LN3 including the merged section SA2 and the merging lane MLN.

In the modification of the first example of the technique for determining whether the host vehicle 10 is traveling in the merged section SA2, the control part 232 determines that the host vehicle 10 is traveling in the merged section SA2 based on the position information of the host vehicle 10 obtained from the GPS unit 5 and the map information obtained from the map information unit 6.

In the example shown in FIG. 6, the merging lane MLN, for example, is doubly provided with the function as a branch lane for heading to an exit of a highway. The zebra zone A13 exists between the merged lane LN3 including the merged section SA2 and the merging lane (branch lane) MLN. The merged section SA2 is comprised of the section between the hard nose A11 and the soft nose A12 in the merged lane LN3 and a section between the soft nose A12 and a branch position A14A.

In a second example of the technique for determining whether the host vehicle 10 is traveling in the merged section SA2, the control part 232 determines whether the host vehicle 10 is traveling in the merged section SA2 based on the image data showing the road environment (for example, road marking of the adjacent lane, installed road signs, etc.) of the vicinity of the host vehicle 10 obtained from the camera 2.

FIG. 7 is a view for explaining a third example of the technique for determining whether the host vehicle 10 is traveling in the merged section (suppression area) SA2. In more detail, FIG. 7 is the view for explaining another example of the relationship between the merged lane LN3 including the merged section SA3 and the merging lane MLN.

In the third example of the technique for determining whether the host vehicle 10 is traveling in the merged section SA3, the control part 232 determines whether the host vehicle 10 is traveling in the merged section SA3 based on the position information of the host vehicle 10 obtained from the GPS unit 5 and the map information obtained from the map information unit 6.

In the example shown in FIG. 7, the nearby vehicle V8 is traveling in the lane LN2 adjacent to the merged lane LN3, the host vehicle 10 is traveling in the merged lane LN3, and the merging vehicle (nearby vehicle) V9 is traveling in the merging lane MLN adjacent to the merged lane LN3 (for example, climbing lane or other lane which disappears due to lane reduction) and trying to merge from the merging lane MLN to the merged lane LN3.

The control part 232 determines that the host vehicle 10 is traveling in the blind spot of the nearby vehicle V8 based on the nearby vehicle information (the information of the nearby vehicle V8 traveling in the lane LN2) acquired by the nearby vehicle information acquisition part 231A. Further, the control part 232 determines that the host vehicle 10 is traveling in the merged section (suppression area) SA3 based on the position information of the host vehicle 10 obtained from the GPS unit 5 and the map information obtained from the map information unit 6.

For this reason, the control part 232 suppresses the blind spot avoidance control performed along with the host vehicle 10 traveling in the blind spot of the nearby vehicle V8.

In the example where for example control is performed for making the host vehicle 10 decelerate as the blind spot avoidance control for making the host vehicle 10 avoid traveling in the blind spot of the nearby vehicle V8, the control part 232 suppresses the blind spot avoidance control by, for example, performing control for suspending performance of the blind spot avoidance control, control for making the operation amount of the braking actuator 15 for making the host vehicle 10 decelerate decrease (for example, control for not allowing the speed of the host vehicle 10 to decrease down to the speed of the merging vehicle V9), etc. As a result, the merging vehicle V9 can smoothly merge from the merging lane MLN to the merged lane LN3 and can become a vehicle following the host vehicle 10.

In the example shown in FIG. 7, the zebra zone does not exist between the merged lane LN3 including the merged section SA3 and the merging lane MLN. The merged section SA3 is comprised of the section between a position A16 at a predetermined distance from the merging end A15 and the merging end A15 in the merged lane LN3.

The merged section SA3 is set to the suppression area in which the blind spot avoidance control performed along with the host vehicle 10 traveling in the blind spot of the nearby vehicle (for example the nearby vehicle V8 etc.) is suppressed. The section other than the merged section SA3 in the merged lane LN3 is set to the permitted area PMA in which the blind spot avoidance control performed along with the host vehicle 10 traveling in the blind spot of the nearby vehicle (not shown) is not suppressed.

In a fourth example of the technique for determining whether the host vehicle 10 is traveling in the merged section SA3, the control part 232 determines whether the host vehicle 10 is traveling in the merged section SA3 based on the image data showing the road environment (for example, road marking of the adjacent lane, installed road signs, etc.) of the vicinity of the host vehicle 10 obtained from the camera 2.

In the first example of the host vehicle 10 to which the vehicle control device 12 of the first embodiment is applied, the control part 232 has the function of determining whether the host vehicle 10 is traveling in the merged section SA2 (see FIG. 5 and FIG. 6) and the function of determining whether the host vehicle 10 is traveling in the merged section SA3 (see FIG. 7).

In a 10th example of the host vehicle 10 to which the vehicle control device 12 of the first embodiment is applied, the control part 232 has the function of determining whether the host vehicle 10 is traveling in the merged section SA2 and may not have the function of determining whether the host vehicle 10 is traveling in the merged section SA3.

In an 11th example of the host vehicle 10 to which the vehicle control device 12 of the first embodiment is applied, the control part 232 does not have the function of determining whether the host vehicle 10 is traveling in the merged section SA2 but may have the function of determining whether the host vehicle 10 is traveling in the merged section SA3.

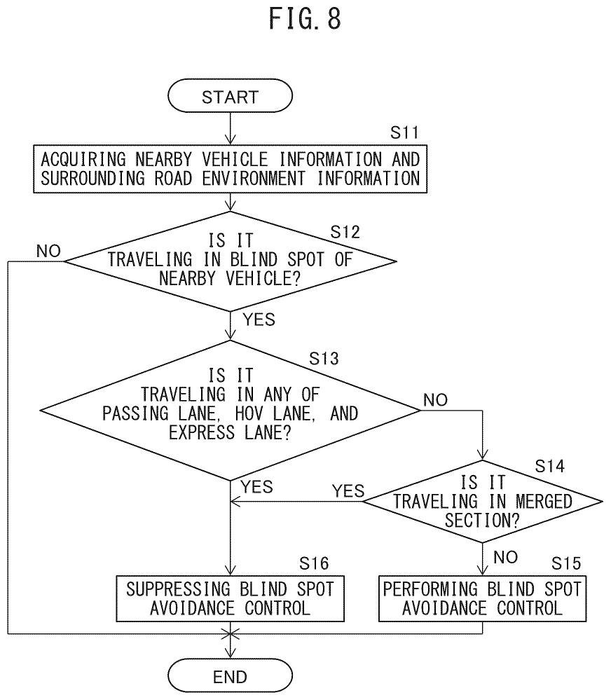

FIG. 8 is a flow chart for explaining one example of the blind spot avoidance control performed by the processor 23.

In the example shown in FIG. 8, at step S11, the acquisition part 231 acquires the nearby vehicle information and the surrounding road environment information of the host vehicle 10.

At step 512, the control part 232 determines whether the host vehicle 10 is traveling in the blind spot of the nearby vehicle based on the nearby vehicle information of the host vehicle 10 acquired at step S11. When YES, it proceeds to step S13, while when NO, it ends the processing shown in FIG. 8.

At step S13, the control part 232 determines whether the host vehicle 10 is traveling in any of the passing lane in road management, the HOV lane as the priority lane, and the express lane as the priority lane based on the surrounding road environment information of the host vehicle 10 acquired at step S11. When the host vehicle 10 is traveling in any of the passing lane in road management, the HOV lane, and the express lane, it proceeds to step S16. On the other hand, when the host vehicle 10 is not traveling in any of the passing lane in road management, the HOV lane, and the express lane, it proceeds to step S14.

At step S14, the control part 232 determines whether the host vehicle 10 is traveling in the merged sections SA2 and SA3 based on the surrounding road environment information of the host vehicle 10 acquired at step S11. When NO, it proceeds to step S16, while when YES, it proceeds to step S15.

At step S15, the control part 232 performs the blind spot avoidance control for making the host vehicle 10 avoid traveling in the blind spot of the nearby vehicle.

At step S16, the control part 232 suppresses the blind spot avoidance control.

As explained above, in the host vehicle 10 to which the vehicle control device 12 of the first embodiment is applied, when the host vehicle 10 is traveling in the blind spot of the nearby vehicle, it is possible to perform the blind spot avoidance control for making the host vehicle 10 avoid traveling in the blind spot of the nearby vehicle. Furthermore, even when the host vehicle is traveling in the blind spot of the nearby vehicle, the blind spot avoidance control is suppressed if there is a possibility of smooth traffic of the host vehicle 10 or nearby vehicle being obstructed. For this reason, in the host vehicle 10 to which the vehicle control device 12 of the first embodiment is applied, it is possible to suitably perform the blind spot avoidance control rather than a case in which the blind spot avoidance control being performed when there is a possibility of smooth traffic of the host vehicle 10 or nearby vehicle being obstructed.

### Second Embodiment

The host vehicle 10 to which the vehicle control device 12 of the second embodiment is applied is configured in the same way as the above-mentioned host vehicle 10 to which the vehicle control device 12 of the first embodiment is applied except for the points explained below. As explained above, in the host vehicle 10 to which the vehicle control device 12 of the first embodiment is applied, as shown in FIG. 5 to FIG. 7, when the host vehicle 10 is traveling in the blind spot of the nearby vehicle and is traveling in the merged section (suppression area) SA2 and SA3, the blind spot avoidance control is suppressed at the merged section (suppression area) SA2 and SA3 without it being considered whether the blind spot avoidance control is performed at the permitted areas PMA before the host vehicle 10 enters the merged section (suppression area) SA2 and SA3 (the permitted area PMA at the left side of the merged section SA2 of FIG. 5 and FIG. 6 and the permitted area PMA at the left side of the merged section SA3 of FIG. 7) (that is, whether the host vehicle 10 travels in the blind spot of the nearby vehicle before the host vehicle 10 enters the merged section SA2 and SA3).

On the other hand, in the host vehicle 10 to which the vehicle control device 12 of the second embodiment is applied, when the host vehicle 10 is traveling in the blind spot of the nearby vehicle and is traveling in the merged section (suppression area), the control part 232 suppresses the blind spot avoidance control by a technique differing depending on whether the blind spot avoidance control is performed in the permitted area before the host vehicle 10 entered the merged section (suppression area) (that is, whether the host vehicle 10 travels in the blind spot of the nearby vehicle before the host vehicle 10 enters the merged section).

Specifically, when the blind spot avoidance control is performed in the permitted area before the host vehicle 10 enters the merged section (suppression area) (that is, when the host vehicle 10 travels in the blind spot of the nearby vehicle in the permitted area before entering the merged section), the control part 232 continues to perform the blind spot avoidance control even while the host vehicle 10 is traveling in the merged section. However, in the merged section, the control part 232 does not make the host vehicle 10 decelerate, but makes the host vehicle 10 avoid traveling in the blind spot of the nearby vehicle. Further, in the merged section, the control part 232 suppresses a rise in speed of the host vehicle 10 to thereby make it harder for the host vehicle 10 to enter the blind spot of the nearby vehicle.

On the other hand, when the blind spot avoidance control is not performed in the permitted area before the host vehicle 10 enters the merged section (suppression area) (that is, when the host vehicle 10 does not travel in the blind spot of the nearby vehicle in the permitted area before entering the merged section), the control part 232 does not start the blind spot avoidance control even after the host vehicle 10 enters the merged section. In more detail, the control part 232 does not start the blind spot avoidance control even when the host vehicle 10 enters the blind spot of the nearby vehicle after the host vehicle 10 enters the merged section. Therefore, the host vehicle is not made to decelerate for making the host vehicle 10 avoid traveling in the blind spot of the nearby vehicle. Further, a rise of the speed of the host vehicle 10 is also not suppressed for making it harder for the host vehicle 10 to enter the blind spot of the nearby vehicle.

Above, embodiments of the vehicle control device, the vehicle control method, and the non-transitory recording medium of the present disclosure were explained with reference to the drawings, but the vehicle control device, the vehicle control method, and the non-transitory recording medium of the present disclosure are not limited to the above embodiments and can be suitably changed within a scope not departing from the gist of the present disclosure. The configurations of the examples of the above embodiments may also be suitably combined.

In the examples of the above embodiments, the processing performed in the vehicle control device 12 (autonomous driving control ECU) was explained as software processing performed by running the program stored in the memory 22, but the processing performed by the vehicle control device 12 may also be processing performed by hardware. Alternatively, the processing performed in the vehicle control device 12 may be processing combining both software and hardware. Further, the program stored in the memory 22 of the vehicle control device 12 (program for realizing the function of the processor 23 of the vehicle control device 12), for example, may be recorded in a computer readable recording medium such as a semiconductor memory, magnetic recording medium, optical recording medium (non-transitory recording medium), etc. and supplied, distributed, etc.

1. A vehicle control device comprising a processor configured to:
acquire nearby vehicle information and surrounding road environment information of a host vehicle; and
perform blind spot avoidance control for making the host vehicle avoid traveling in a blind spot of a nearby vehicle based on the nearby vehicle information, wherein
the processor is configured to perform at least one of
suppression of the blind spot avoidance control while the host vehicle is traveling in passing lane or priority lane based on the surrounding road environment information and
suppression of the blind spot avoidance control while the host vehicle is traveling in a merged section based on the surrounding road environment information.

2. The vehicle control device according to claim 1, wherein the processor is configured to
determine whether to suppress the blind spot avoidance control and
calculate acceleration and deceleration of the host vehicle for suppressing the blind spot avoidance control.

3. The vehicle control device according to claim 1, wherein the processor is configured to determine whether the host vehicle is traveling in any of the passing lane, HOV (high occupancy vehicle) lane, and express lane based on at least one of position information and map information of the host vehicle obtained from GPS unit and map information unit provided in the host vehicle and image data of the vicinity of the host vehicle obtained from a camera provided in the host vehicle.

4. The vehicle control device according to claim 1, wherein the processor is configured to determine whether the host vehicle is traveling in the merged section based on at least one of position information and map information of the host vehicle obtained from GPS unit and map information unit provided in the host vehicle and image data of the vicinity of the host vehicle obtained from a camera provided in the host vehicle.

5. The vehicle control device according to claim 1, wherein
a zebra zone exists between a merged lane which is a lane including the merged section and a merging lane, and
the merged section is comprised of a section between a hard nose and a soft nose in the merged lane and a section between the soft nose and a merging end.

6. The vehicle control device according to claim 1, wherein
a zebra zone does not exist between a merged lane which is a lane including a merged section and a merging lane, and
the merged section is comprised of a section between a position at a predetermined distance from a merging end and the merging end in the merged lane.

7. The vehicle control device according to claim 1, wherein when the host vehicle moves from outside the merged section to inside the merged section in a state in which the processor is performing the blind spot avoidance control, the processor is not configured to perform control for making the host vehicle decelerate for performing the blind spot avoidance control, but is configured to perform speed increase suppression control of the host vehicle, and
when the host vehicle moves from outside the merged section to inside the merged section in a state in which the processor is not performing the blind spot avoidance control, the processor is not configured to start the blind spot avoidance control.

8. A vehicle control method comprising:
acquiring nearby vehicle information and surrounding road environment information of a host vehicle; and
performing blind spot avoidance control for making the host vehicle avoid traveling in a blind spot of a nearby vehicle based on the nearby vehicle information, wherein
at least one of
suppression of the blind spot avoidance control while the host vehicle is traveling in passing lane or priority lane based on the surrounding road environment information and
suppression of the blind spot avoidance control while the host vehicle is traveling in a merged section based on the surrounding road environment information, is performed.

9. A non-transitory recording medium having recorded thereon a computer program for causing a processor to execute a process comprising:
acquiring nearby vehicle information and surrounding road environment information of a host vehicle; and
performing blind spot avoidance control for making the host vehicle avoid traveling in a blind spot of a nearby vehicle based on the nearby vehicle information, wherein
at least one of
suppression of the blind spot avoidance control while the host vehicle is traveling in passing lane or priority lane based on the surrounding road environment information and
suppression of the blind spot avoidance control while the host vehicle is traveling in a merged section based on the surrounding road environment information, is performed.
